(19) United States
(12) Patent Application Publication
(10) Pub. No.: US 2006/0097522 A1
(43) Pub. Date: May 11, 2006

(54) Combined rotor latch and solenoid

(75) Inventors: William D. Denison, Lake Zurich, IL (US); Gary L. Myers, Monee, IL (US); Richard Paeth, St. Charles, IL (US); Catalin Captarencu, Wheeling, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, LLC, Elk Grove, IL (US)

(21) Appl. No.: 11/247,471

(22) Filed: Oct. 11, 2005

Related U.S. Application Data
(60) Provisional application No. 60/617,993, filed on Oct. 12, 2004.

(51) Int. Cl. E05C 3/06

(52) U.S. Cl. 292/201

(57) ABSTRACT

The present invention provides an improved latching device that functions as a self-contained, electrically controlled rotor latch. The latch allows the rotor to be released when a load is placed on it towards the open condition. The latch rotor is released by a typical solenoid with a specialty designed end that acts as a plunger.

### CROSS REFERENCE TO RELATED APPLICATION

This application claims priority to U.S. Provisional Patent Application 60/617,993, filed on Oct. 12, 2004, which is incorporated herein by reference in its entirety.

### TECHNICAL FIELD

The present invention relates generally to latches for cabinet-type utility enclosures and, more particularly, to a rotor latch and strike interface control system.

### BACKGROUND OF THE INVENTION

Rotor latches have been used to secure many types of utility enclosures and automotive doors. The rotor generally interfaces to a pin, such as by capturing the pin, or extends around the edge or corner of a metallic structure in order to latch. It is common to install a rotor latch in a frame of an enclosure and to install the pin on the door. The rotor and pin can also be mounted in a reverse configuration. Latching is usually accomplished when the rotor strikes the pin or strike, forcing it to rotate into a latched position. Unlatching is usually accomplished by enabling the latch to rotate in the opposite direction from the latched position, thus freeing the pin or strike from engagement. The enabling device is sometimes a handle. The handle's motion may be locked or unlocked by a mechanical lock core and key. In electric applications, the motion of the handle is often controlled by an electric actuator such as a solenoid or motor.

A disadvantage of an enclosure with a mechanically controlled traditional rotor latch as described above is that it will typically have an unattractive looking handle or mechanical lock mounted to the exterior of the door. Another disadvantage is that a single latch point is often insufficient to secure the enclosure. Another disadvantage is that the interface between the rotor and the pin or strike may have a high degree of friction.

### SUMMARY OF THE INVENTION

In view of the foregoing, the present invention improves on the methods, operations, and interfaces of latching and unlatching a hinge. The present invention makes it possible to remove certain components from the outside of an enclosure door. This improvement enhances security by providing a more difficult point of attack. It also provides additional exterior surface area on which to add decorative features to the enclosure door.

In one embodiment, this invention provides a combination of rotor latches to enhance the latching of an enclosure. In a mechanism consisting of more than one rotor latch, a common unlatching system connects to each latch to simultaneously unlatch all of the latches. The common unlatching system can be mechanical, such as a rod or a pin to control the rotor. It can be either electronically controlled by a solenoid or actuator or mechanically controlled by a quarter-turn cam lock or other mechanical actuator.

In one embodiment, the present invention provides a mechanical indicator that can be seen from outside the enclosure to indicate the status of the latch position (or the status of the positions of the multiple latches if so provided).

In one embodiment, the present invention includes a roller over the strike or pin to reduce the friction of the mechanical interface between the rotor and the pin or strike.

In one embodiment, an enclosure has a plurality of rotor latches and pins or strikes at opposite sides of the enclosure to allow the enclosure to be opened from either side. In this embodiment, at least two rotor latches on the near side of the enclosure are used to access the enclosure, and at least two latches on the far side of the enclosure act as a hinge of the enclosure when the enclosure is opened from the near side, and vice versa. In this embodiment, one or more of the rotor latches are configured to act as a common hinge axis.

This invention is not limited to any particular type, style, or application of enclosure. In addition, although the preferred embodiment of the invention includes a door with single rotor latch interfacing to a single pin or strike in the cabinet of the enclosure, this invention also supports the opposite arrangement such as a rotor latch in a cabinet that interfaces into a pin or strike in the door frame, as well as many other types of door, cabinet, and mechanism arrangements as are available.

The first object of the invention is to improve the locking and unlocking operation of an enclosure interfaced to an improved rotor latch and pin or strike mechanism.

The second object is to replace the manual access control of the rotor with an electronic access control.

The third object is to provide a faster method for accessing and locking the enclosure.

The fourth object is to provide an enclosure that can be reliably accessed from either end of the enclosure.

The fifth object is to provide a more user-friendly electronically controlled device to access and lock the door.

The sixth object is to provide a device that is battery powered, although the invention is not limited to battery-controlled operation.

The seventh object is to provide a rotor latch that when latched can operate as a common hinge.

The eighth object is to provide an improved rotor latch that can be effectively unlatched while a load force is applied to an opposite member of the rotor latch.

The ninth object is to provide an improved rotor-latch system that indicates to a user whether proper engagement and latching has occurred.

The tenth object is to provide a single-point access control for single- or multiple-point latches.

The eleventh object is to provide a latch system that supports many types of locking-control devices such as keys, handles, and electronics.

The twelfth object is to provide a structure for mounting the latches and for adding support to an enclosure.

The thirteenth object is to provide a user with audible feedback of the latching function.

The fourteenth object is to provide a user with a method to overcome any malfunctions of the mechanism using the locking-control devices.

The fifteenth object is to provide a latching device that withstands common temperature variations without a degradation of operation.

The sixteenth object is to provide a strike with reduced friction.

### BRIEF DESCRIPTION OF THE DRAWINGS

While the appended claims set forth features of the present invention, the invention, together with its objects and advantages, may be best understood from the following detailed description taken in conjunction with the accompanying drawings of which:

FIGS. 1a through 1d are views of the rotor-latch mechanism according to an embodiment of the present invention; FIGS. 1a and 1b show how the rotor-latch mechanism interfaces to a door; FIG. 1c is an exploded view of a solenoid assembly; FIG. 1d is an isometric view of the solenoid assembly; and

FIGS. 2 through 5 are perspective views of an electric rotor-latch mechanism.

### DETAILED DESCRIPTION OF THE INVENTION

The following description is based on illustrative embodiments of the invention and should not be taken as limiting the invention with regard to alternative embodiments that are not explicitly described herein.

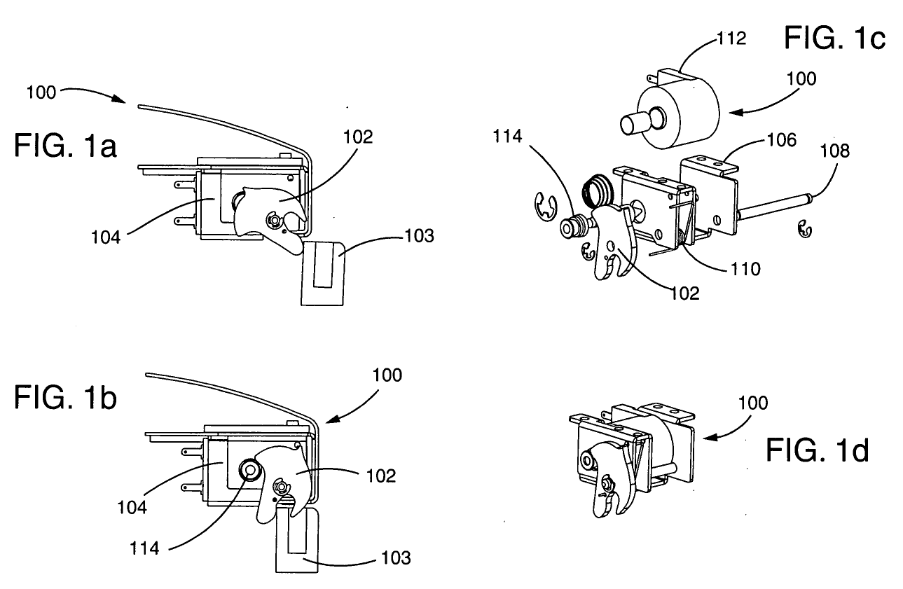

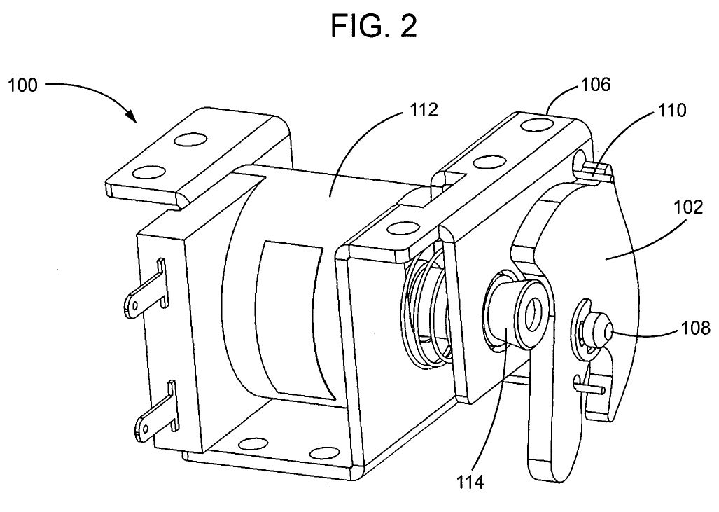

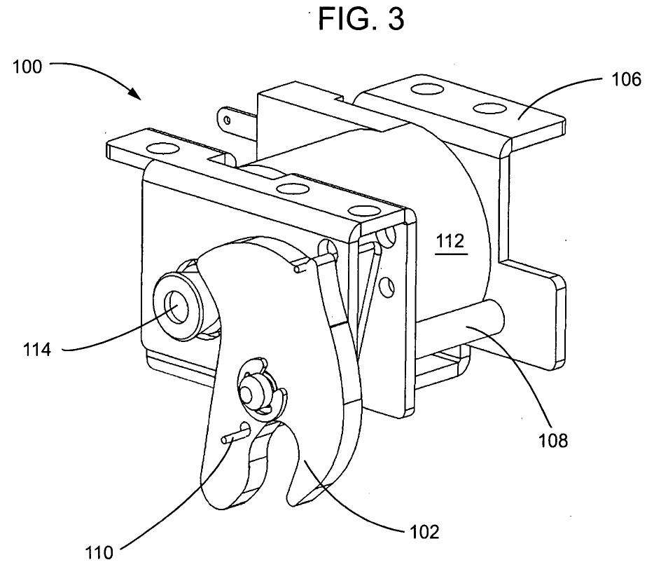

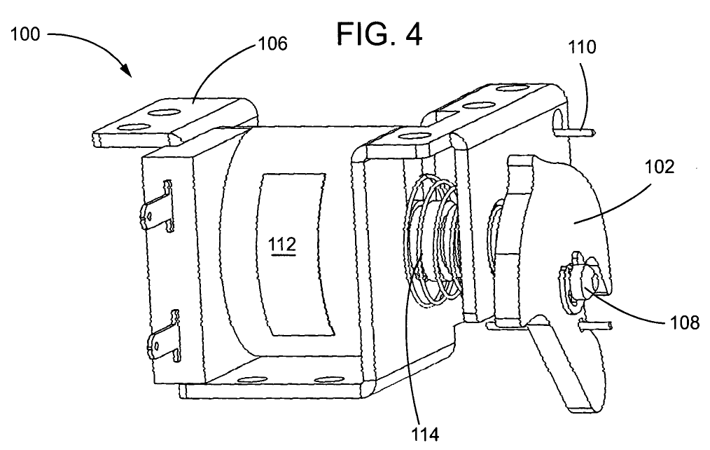

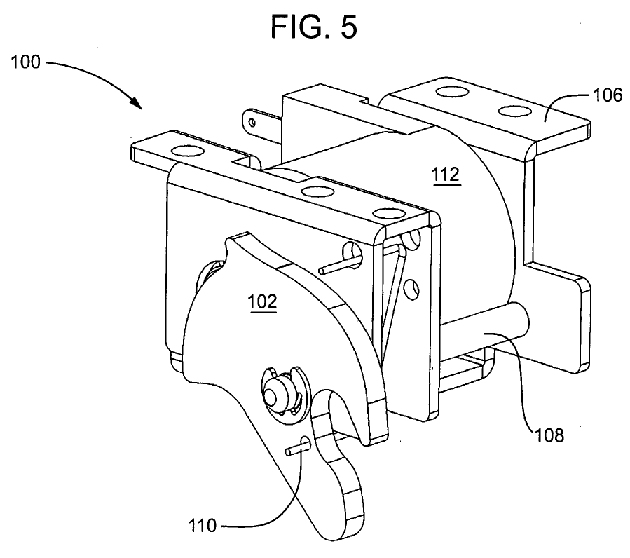

Turning to the drawings, FIG. 1a shows an embodiment of the present rotor latch 100 including a rotor 102 and a latch-release mechanism 104 which is mechanically or electrically locked. A structure intended to represent the door is shown as 103. If the rotor latch 100 is mechanically locked, then it includes a lock core or a handle with lock core. If the rotor latch 100 is electronically locked, then it includes an electronic control interface added to a mechanical release mechanism, an access control device, and a power source. FIG. 1a shows the door in an unlocked position, while FIG. 1b shows the same door locked and secured by the rotor 102.

Turning to FIG. 1c, the rotor latch 100 includes a solenoid frame 106 that supports the rotor pivot shaft 108, rotor detect spring 110, solenoid coil 112, and plunger 114, as well as providing a structure for controlling the strike surface. Control surfaces allow the strike to rotate while keeping the strike confined, thereby preventing the member to which the strike is attached from becoming dislodged.

The rotor 102 pivots about an axis parallel to the door's hinge axis. The rotor latch 100 is constructed from high-strength materials such as steel or brass. The rotor latch 100 has two states of operation: latched (strike surface engaged) and unlatched (strike surface not engaged). The rotor latch 100 can be spring or gravity biased to its unlatched position, but that is not required for operation. Motion of the rotor 102 is governed by the plunger 114 moving in and out of contact with it. The force required to generate the motion to the strike comes from direct input from a user, either by pulling the strike out of engagement or by pushing it into engagement. This operation is similar to that of a common automobile door lock.

The rotor 102 is prevented from rotation when latched by the spring-biased, linear motion, physical blocking plunger 114. The plunger 114 moves perpendicularly to the rotor pivot shaft 108. The interface to the rotor 102 when latched is relatively small. The physical blocking device indicator (a key or handle) can easily overcome the friction from its small cross section. By requiring the use of a small section, the blocking device's motion is not critical to proper operation.

The rotor 102 also has a provision on its outer surface to detent the rotor 102 into a position that removes rotational forces from the plunger 114. This detent interfaces to a spring axle that may or may not have a roller on it. This area of contact provides a method for removing rotational forces from the plunger 114 and for allowing it to rotate freely when energized.

In a preferred embodiment, the locking event for the enclosure door is controlled by an access signal from an access-control unit. Examples of both keypad- and remote-controlled access-control units are described in U.S. Pat. Nos. 5,617,082 and 6,359,547 and in U.S. Published Patent Application US2003/0234719A1, which are incorporated herein by reference in their entireties.

Where a keypad lock mounted to an enclosure is used to access the motor control as described in the patents listed above, the keypad lock offers a simple user interface of keys (such as twelve access buttons) and LED lights or an LCD display to help the user enter access control commands, enter additional access codes, check the health of the battery, etc.

When an access-control unit is desired that has no point of attack, a wireless remote control device may be used. Such a wireless access device is described in U.S. Pat. No. 5,617,082. This device offers a battery-saver feature to reduce power consumption of the lock as it waits to receive an access-code transmission. Two examples of wireless media used for this device are radio frequency and infrared. The battery-saver feature can be implemented in a number of ways: (a) full-time wherein batteries are used to power the lock; (b) not at all wherein the power to the lock is a DC power source; (c) a combination of these two modes, wherein the power-saver mode is used when it is not expected that the lock will be immediately accessed or re-locked, and wherein the full-power mode is used when it is expected that the lock may be immediately accessed or re-locked. A less desirable aspect of the battery-saver feature is a time-delayed reaction to a lock or unlock access input. The dual mode takes advantage of the power-saver during long time periods when the lock most likely is not being locked or unlocked and takes advantage of the full-power mode to react quickly to a lock or unlock access-control signal.

Wireless access-control devices may take may forms, such as a remote transmitter with a single access-code transmit button. When this single transmitter button is pressed, the complete access code is transmitted to the access-control receiver, as described in U.S. Published Patent Application US2003/0234719A1. Alternately, the wireless device reads biometric input such as a fingerprint to replace a single button as the user interface.

The remote unit can also include several keypad buttons (labeled, for example, “0” through “9”) to allow a user to enter input combinations to make up an access code. As each button is pressed, an individual, unique code representing that button is transmitted to the access-control unit. The order and combination of the codes received from the remote make up the access code for the enclosure. An example of such a device is the universal remote-control unit for a television or other consumer device.

In the example given above of a universal remote-control unit, problems exist with annunciation and with user-friendly operation of the lock. For example, the universal remote typically contains only an LED light indicating that a button was pressed and that a code was transmitted, but there is no confirmation that a particular code was received by the access-control unit. Embodiments of the present invention offers two solutions to these problems.

As a first solution, the access-control unit contains an annunciation device such as LED lights, an LCD display, or an audio annunciator to provide feedback for the user as to exactly how many key presses are received by the remote transmitter. Note that these annunciations do not give any positive or negative feedback as to whether the code received was valid or invalid, only that it was received. It also attempts to annunciate the order in which each code is received. For example, if the expected code contains five digits, then the annunciator may attempt to either light or un-light one LED for each code received, providing both feedback that the code was received and what receiving sequence this code was in as it was received. Typically, this annunciator is located such that it can be viewed from just in front of the door (say, up to ten feet back from the door). Other messages may also be displayed such as a confirmation that the complete correct code was received, that an incorrect complete code was received, that the battery is low, that an incorrect button was pressed, or that the mechanism should be unlocking.

As a second solution, the access-control unit can contain a transmission system (typically using the same transmission medium as used by the remote unit), and the remote transmission unit can contain a wireless receiver system to receive the annunciation messages from the access-control unit. The same annunciation components can be used at the remote unit. Thus, the user transmits a code via the control unit; if received, the access-control transmits a confirmation back to the remote unit; and the remote unit displays an annunciation message to the user that the code was received. Other messages may be displayed just like the ones mentioned above.

The lock system can be power either by a battery source or by an AC or DC power source. If batteries are used, then it is assumed that they are mounted inside the enclosure and are not accessible while the door is locked. The batteries are monitored for their health, and a measure of that health is announced to the user as the enclosure is accessed or locked. The batteries are usually non-rechargeable alkalines, although rechargeable types are possible.

In the event that the batteries are too low to operate the unit, the preferred embodiment has a power input port that accepts a back-up power source to power the lock thus allowing the lock mechanism to unlock once a correct access code is received. This port does not provide a hotwire to over-ride the access-control system of the lock. Once such battery-back-up unit is described in U.S. Provisional Patent Application 60/523,505. In some cases, a simple nine-volt battery can be used.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Therefore, the invention as described herein contemplates all such embodiments as may come within the scope of the following claims and equivalents thereof.

We claim:

1. A rotor-latch system, the system comprising:
a solenoid frame;
a rotor pivot shaft supported by the solenoid frame;
a rotor attached to the rotor pivot shaft, the rotor rotatable about an axis of the rotor pivot shaft;
a rotor detect spring supported by the solenoid frame;
a solenoid supported by the solenoid frame; and
a plunger adapted to move linearly under an impetus of the solenoid, the plunger acting to lock or unlock the rotor.

2. A rotor-latch system, the system comprising:
a frame;
a rotor pivot shaft supported by the frame;
a rotor attached to the rotor pivot shaft, the rotor rotatable about an axis of the rotor pivot shaft;
a rotor detect spring supported by the frame; and
a mechanical actuator adapted for locking or unlocking the rotor.
